(19) United States
(12) Patent Application Publication
(10) Pub. No.: US 2015/0151917 A1
(43) Pub. Date: Jun. 4, 2015

(54) System, Method And Apparatus For Facilitating The Repair Of A Conveyor Belt Roller Assembly

(71) Applicant: Clyde CAMPBELL, Hornsby, New South Wales (AU)

(72) Inventor: Clyde Campbell, Hornsby (AU)

(21) Appl. No.: 14/410,894

(22) PCT Filed: Jun. 28, 2013
(86) PCT No.: PCT/AU2013/000709

§ 371 Date: Dec. 23, 2014

(30) Foreign Application Priority Data
Jun. 29, 2012 (AU) 2012902777

(51) Int. Cl. B65G 15/60; B23P 6/00; B65G 39/12

(52) U.S. Cl. CPC B65G 15/60; B65G 39/12; B23P 6/00

(57) ABSTRACT

An apparatus for facilitating repair of a conveyor belt idler frame assembly during operation of a conveyor, the apparatus comprising: an interim belt support structure comprising one or more rollers, the support structure being operable to be positioned adjacent the idler frame assembly and, once so positioned, being further arranged to anchor to a support portion of the conveyor; and an elevating arrangement arranged to elevate the roller(s) of the interim belt support structure into engagement with a moving belt of the conveyor to facilitate the repair.

### TECHNICAL FIELD

The present invention relates to techniques for facilitating the repair of a conveyor belt roller assembly which includes one or more serviceable rollers. Embodiments find particular but non-limiting application for facilitating the repair of roller assemblies found in a cradle conveyor belt commonly used in the mining industry. The present invention also relates to a conveyor belt roller assembly inspection tool.

### BACKGROUND TO THE INVENTION

Belt conveyors are widely used in the mining industry for transporting material from one part of the mine to another. A conveyor belt is supported by spaced apart roller assemblies (often referred to as an ‘idler and frame’) which each include one or more rollers for facilitating movement of the belt.

The idler rollers mounted to the frame assemblies need to be periodically replaced either due to their surface becoming warn over time or due to early failure (e.g. where an internal bearing has failed). Existing methods for replacing the worn/faulty rollers require that the conveyor be shut down so as to allow an operator to safely access the roller. To avoid unexpected shut downs, the conveyor will typically be shut down for routine servicing during which time each of the rollers will be replaced. As will be appreciated such servicing can present unnecessary expense since all of the rollers are replaced irrespective of whether they are in need of replacement or not. The servicing also results in extended downtime which can have a serious impact on the productivity of the mine. Further, the roller replacement process can present a serious operational health and safety risk to operators, due to the heavy lifting required to lift and manipulate the rollers into and out of position, as well as the need for operators to work in an around the conveyor which is a known hazardous environment.

### SUMMARY OF THE INVENTION

In a first aspect the present invention provides an apparatus for facilitating repair of a conveyor belt idler frame assembly during operation of a conveyor, the apparatus comprising:

an interim belt support structure comprising one or more rollers, the support structure being operable to be positioned adjacent the idler frame assembly and, once so positioned, being further arranged to anchor to a support portion of the conveyor; and

an elevating arrangement arranged to elevate the roller(s) of the interim belt support structure into engagement with a moving belt of the conveyor to facilitate the repair.

In an embodiment the elevating arrangement is configured to elevate the roller(s) to a height such that the moving belt is no longer in contact with rollers on the adjacently located idler frame assembly.

In an embodiment the elevating arrangement comprises a mechanical actuator.

In an embodiment the mechanical actuator comprises a hydraulic cylinder.

In an embodiment the apparatus further comprising a manipulatable robot arm arranged to removably couple to the interim belt support structure and, when so coupled, to guide the interim belt structure into the adjacent position.

In an embodiment the manipulatable robot arm comprises a sensing means arranged to sense an area adjacent the idler frame assembly to be repaired for determining how to guide the interim belt structure into the adjacent position without contacting the moving belt.

In an embodiment the manipulatable robot arm comprises a user input for allowing the interim belt support structure to be guided into position by an operator.

In an embodiment the manipulatable robot arm is mounted to a movable platform comprising a drive means for driving the manipulatable robot arm into a suitable position for facilitating guiding of the interim belt support structure into the adjacent position.

In an embodiment the interim belt support structure is arranged to anchor to one or more support rails of the conveyor on which the idler frame assembly is mounted.

In accordance with a second aspect of the invention there is provided a conveyor belt system comprising:

a conveyor belt comprising a plurality of conveyor idler frame assemblies arranged to carry a moving belt; and

an apparatus as claimed in any one of claims 1 to 9, for facilitating repair of one of the idler frame assemblies.

In accordance with a third aspect of the invention there is provided a method for repairing an idler frame assembly supporting a conveyor belt during operation of a conveyor, the method comprising:

positioning an interim belt support structure comprising one or more rollers adjacent the idler frame assembly;

anchoring the interim belt support structure in the adjacent position; and

elevating the roller(s) of the interim belt support structure into engagement with a moving belt of the conveyor to facilitate the repair.

In an embodiment the method further comprises elevating the roller(s) to a height such that the moving conveyor belt is no longer in supported by the adjacently located idler frame assembly.

In an embodiment the method further comprises replacing or repairing one or more of the rollers of the adjacently located idler frame assembly while the interim belt support structure is taking the load of the moving belt off the idler frame assembly.

In an embodiment the method further comprises lowering the height of the roller(s) of the interim belt support structure after the one or more rollers have been replaced or repaired.

In an embodiment the method further comprises removing the interim belt support structure from the adjacently located position.

In accordance with yet a further aspect of the present invention there is provided a roller replacement apparatus for facilitating repair of a conveyor belt idler frame assembly mounting one or more rollers, the apparatus comprising:

a manipulatable arm coupled to a retaining portion and being arranged to move the retaining portion into a position adjacent one of the rollers mounted by the idler frame assembly such that when so positioned the retaining portion is arranged to receive and retain the roller by way of spindles disposed on either end thereof.

In an embodiment the retaining portion comprises a pair of plates disposed on either end of a body, each of the plates comprising a spindle retaining channel operable to receiving a respective spindle of the roller.

In an embodiment the retaining portion further comprises on or more movable projections which extend from the body and which are locatable under the roller when the retaining portion is located in the adjacent position, in use the projection(s) being moveable so as to bear on the roller for causing the spindles to move out of the mounted position on the idler frame assembly and into the respective spindle retaining channels.

### BRIEF DESCRIPTION OF THE DRAWINGS

An embodiment of the present invention will now be described, by way of example only, with reference to the accompanying drawings, in which:

FIG. 1 is a perspective partial view of a cradle belt conveyor;

FIG. 2 is a close up view of a roller;

FIG. 3 is a close up view of a conveyor belt idler and frame assembly;

FIGS. 4a and 4b are perspective views showing an apparatus for facilitating the repair of an idler and frame assembly, in accordance with an embodiment of the present invention;

FIG. 5 is a perspective view of the FIG. 4 apparatus, in an operational position;

FIG. 6 is a perspective view of a robotic arm, in accordance with an embodiment;

FIG. 7 is a perspective view of a gripping arrangement in accordance with an embodiment;

FIG. 8 is an exploded view of the gripping arrangement of FIG. 7;

FIG. 9 is a perspective view showing the gripping arrangement being moved into position;

FIG. 10 is a perspective view showing the gripping arrangement removing a worn roller;

FIG. 11 is a perspective view of an alternative embodiment of a belt lifting apparatus;

FIG. 12 is a perspective view of a further alternative embodiment of a belt lifting apparatus;

FIG. 13 is a perspective view of an alternative embodiment of a roller replacement apparatus;

FIG. 14 is a detail view of the retaining mechanism of the roller replacement apparatus of FIG. 13;

FIG. 15 is a perspective view of an inspection tool;

FIG. 16 shows a partial perspective view of a typical underground conveyor assembly;

FIG. 17 is a perspective view of a frame of an alternative embodiment of belt lifting apparatus;

FIG. 18 is a perspective view of an insert for use with the frame of FIG. 17;

FIG. 19 shows the insert of FIG. 18 engaged with the frame of FIG. 17;

FIG. 20 is a perspective view of an alternative embodiment of insert for use with the frame of FIG. 17;

FIG. 21 is a perspective view showing the frame of FIG. 17 and the insert of FIG. 20 in use to lift the return run of an underground conveyor assembly;

FIG. 22 is a perspective view of modular storage units;

FIG. 23 shows the modular storage units of FIG. 22 mounted on a truck in association with a robotic arm;

FIG. 24 is an underside perspective view of a further alternative embodiment of a belt lifting apparatus;

FIG. 25 is an upper perspective view of the belt lifting apparatus of FIG. 24;

FIGS. 26a to 26d are cross sectional views of an above ground conveyor assembly illustrating installation of the apparatus of FIG. 24 to the conveyor assembly;

FIG. 27 is an upper perspective view showing the apparatus of FIG. 24 being installed on a conveyor assembly; and

FIGS. 28a to 28c are side views illustrating the final steps of installing apparatus 800 to a conveyor assembly.

### DETAILED DESCRIPTION OF EXEMPLARY EMBODIMENTS OF THE INVENTION

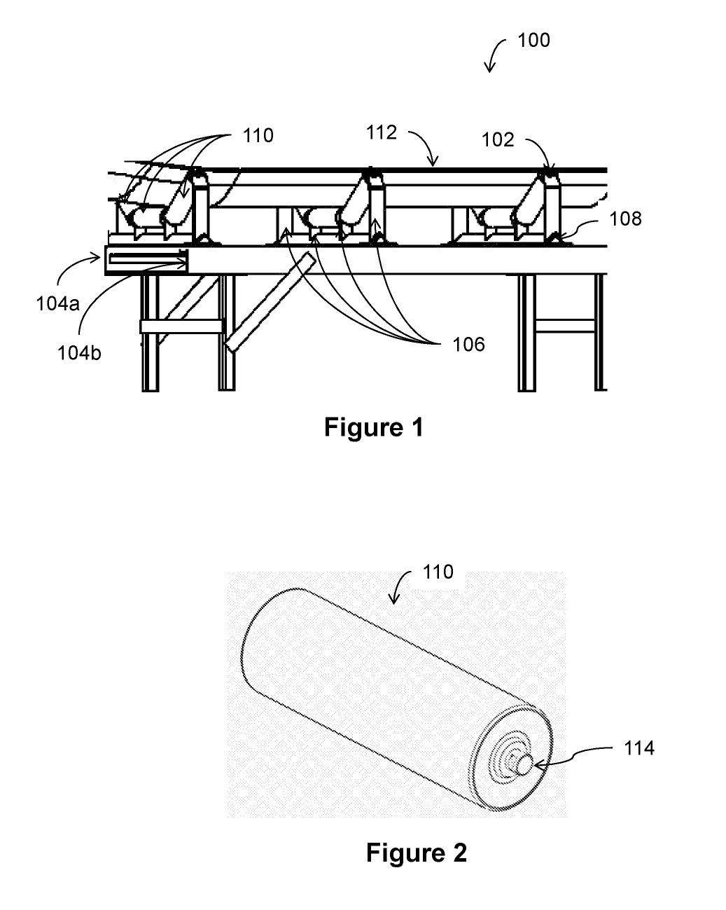

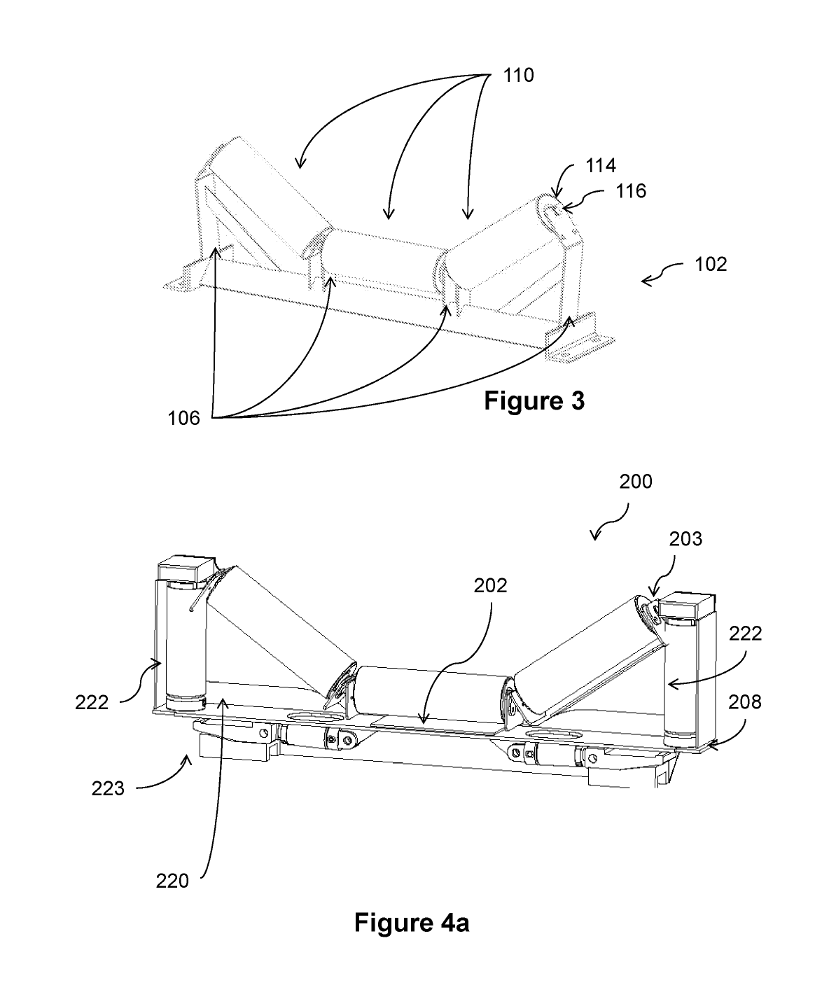

Embodiments of the present invention are suitable for use with a belt conveyor, such as a cradle belt conveyor 100 as generally shown in the partial view of FIG. 1. As shown in FIG. 1, the conveyor 100 comprises a plurality of idler and frame assemblies 102 which are supported by (and in this case welded to) a pair of elevated rails 104a, 104b running the length of the conveyor 100. The assemblies 102 are typically made of steel and comprise a number of stanchions 106 which extend from an assembly base 108 so as to mount a plurality of rollers 110 for supporting a belt 112. In this case the assemblies 102 mount three rollers 110 for supporting the belt 112 in a cradle like fashion. The rollers 110 are conventional conveyor rollers consisting of a cylindrical tube body with spindles 114 projecting from either end thereof, as is best shown in the close-up view of FIG. 2. One or more rolling-element bearings are sealed within the tube body as is well understood by persons skilled in the art. As shown in the close-up view of FIG. 3, the spindles 114 seat within channels 116 defined in the corresponding stanchions 106 for mounting the rollers 110. As discussed in the preamble, the rollers 110 must be replaced periodically (i.e. either due to normal wear, or in some cases due to early failure) in order for the belt conveyor to maintain a smooth operation.

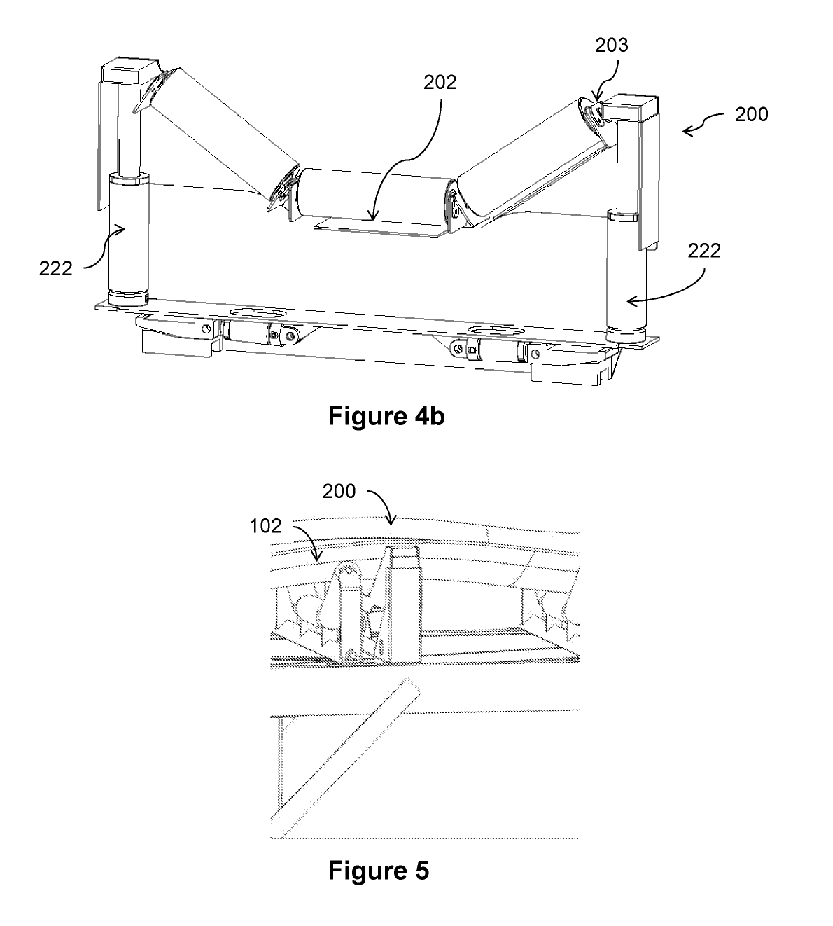

With reference to FIGS. 4a and 4b, there is shown an apparatus 200 according to an embodiment of the present invention, which is operable to facilitate the repair of an idler and frame assembly 102 (e.g. to repair or replace worn/faulty rollers) while the conveyor 100 is in operation. FIG. 4a shows the apparatus 200 in a lowered configuration for positioning, while FIG. 4b shows the apparatus in an elevated position for facilitating the repair. Like the frame and idler assembly 102, the apparatus 200 is configured to mount three rollers 110 for cradling the belt 112. According to the specific embodiment illustrated in FIGS. 4a and 4b, the apparatus 200 comprises an interim belt support structure 202 in the form of a steel frame which mounts the three rollers 110 (although in this case the rollers 110 are permanently secure to the structure 202 by way of retaining clips 203). The interim belt support structure 202 is mounted to an elevating arrangement 220 for elevating the interim belt support structure 202, as will described in more detail in subsequent paragraphs.

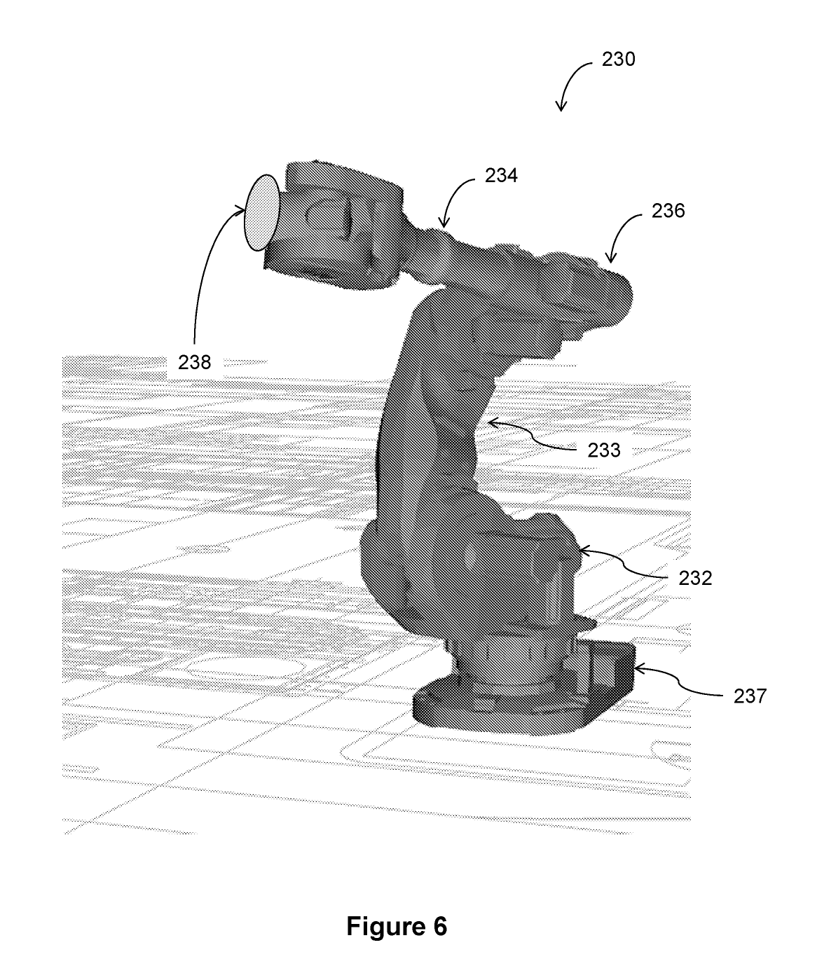

While in the lowered configuration shown in FIG. 4a, the apparatus 200 is located adjacent the assembly 102 and into an operational position by manoeuvring the structure 202 under the moving belt 112 without contacting the belt 112 (which typically involves lying the structure 202 down in a horizontal fashion for inserting between the belt 112 and rails 104 before rotating it into an upright position). FIG. 5 shows the apparatus 200 having been located into an operational position adjacent the assembly 102 under repair. In a particular embodiment, this is achieved by way of a mechanical actuator in the form of a robotic arm 230 which is removably attached to the apparatus 200. As shown in FIG. 6, the robotic arm 230 includes a rotatable base portion 232 to which is mounted a first arm portion 233 which is rotatable with respect to base portion 232 about a horizontal axis. A second arm portion 234 of the robotic arm 230 is pivotally and rotatably mounted to first arm portion 232 by way of elbow joint portion 236. A wrist portion 238 is in turn pivotally and rotatably mounted to the second arm portion 234. A suitable arrangement for use in this application would be one of the IRB 7600 range of industrial robots available from ABB Robotics ( ).

The wrist portion 238 is fitted with an attachment means (not shown) for attachment to the apparatus 200. In a particular embodiment, the attachment means comprises a series of bolts which are locatable through corresponding bolt holes defined in an end stanchion of the support structure 202. Nuts are fastened over the located bolt ends to secure the apparatus to the robotic arm 230. In an embodiment, the rotatable base portion 232 of the robotic arm 230 may be mounted on a vehicle platform (by way of fixed portion 237) to allow the apparatus 200 to be moved into position, and from one part of the conveyor to another (e.g. for repairing other assemblies along the conveyor belt line). The vehicle may be any suitable vehicle including a telescopic handler, IT truck, fork-lift truck, or the like. In a particular embodiment the robotic arm 230 may be mounted to a railed vehicle which travels on rails located alongside the conveyor 100. Alternatively, the apparatus 200 may be mounted by an overhead or underslung gantry, or by way of a side slung linear track system.

The robotic arm 230 is controlled by a computing system configured with suitable control software. A database storing information in relation to features of the apparatus 200 and conveyor 100 including the locations of the assemblies 102 is pre-prepared and may be utilised by the control software to guide the apparatus 200 into position without contacting the moving belt 112. Further, the various articulated joints of the robotic arm 230 may be fitted with positional sensors for communicating with the control software to allow accurate positioning of the apparatus 200 with respect to the belt 112 during the positioning operation. In an alternative embodiment, the robotic arm 230 may be fitted with sensors such as laser and vision sensors, as well as mechanical sensors in the arm 230 which communicate with the control software to allow the apparatus 200 to be automatically and dynamically guided into position without contacting the moving belt. In yet another alternative embodiment, the robotic arm 230 may be manually guided into position by an operator using a suitable control means, such as a joystick or the like.

Once in position, the support structure 202 is removably anchored to the pair of elevated support rails 104a, 104b by way of an anchoring means in the form of a hydraulic clamp 223 (although it will be understood that any suitable anchoring means could be used depending on the actual implementation and rail configuration, including manual clamps, temporary welds, among others) which is coupled to a base portion 208 of the elevating arrangement 220. Once anchored, the elevating arrangement 220 is arranged to elevate the interim belt support structure 202 (as shown in FIGS. 4b and 5) for facilitating the repair of an adjacently located conveyor belt roller assembly 102. The elevating arrangement 220 may comprise any suitable mechanic actuator capable of lifting the interim belt support structure 202, although according to the embodiment described herein is in the form of a hydraulic power system comprising a pair of hydraulic cylinders 222 located on either end of the base portion 208. Other mechanical actuators suitable for use with the elevating arrangement may comprise, for example, geared electric motors or the like.

A basic process for installing the apparatus 200 will now be described. In a first step S1, the interim belt support structure 202 is coupled to the robot arm 230 and positioned adjacent the assembly 102 (either in an automated fashion or by a human operation, as afore-described). It will be understood that the distance between the belt support structure 202 and adjacently located assembly 102 will vary depending on the actual implementation of the conveyor 100, however according to the illustrated embodiment is approximately 1 to 2 meters. Once located in the position, the apparatus 200 is anchored to the respective rails 104a, 104b using the hydraulic clamp configuration (step S2). At step S3, the cylinders 222 of the elevating arrangement 220 are actuated causing the rollers 110 mounted on the support structure 202 to be elevated into engagement with the moving belt 112. The cylinders 222 continue to elevate the rollers 110 until the belt 112 is no longer in contact with the rollers 110 of the adjacently located assembly 102, to thereby allow the assembly 102 to be repaired. The robot arm is subsequently detached (step S4).

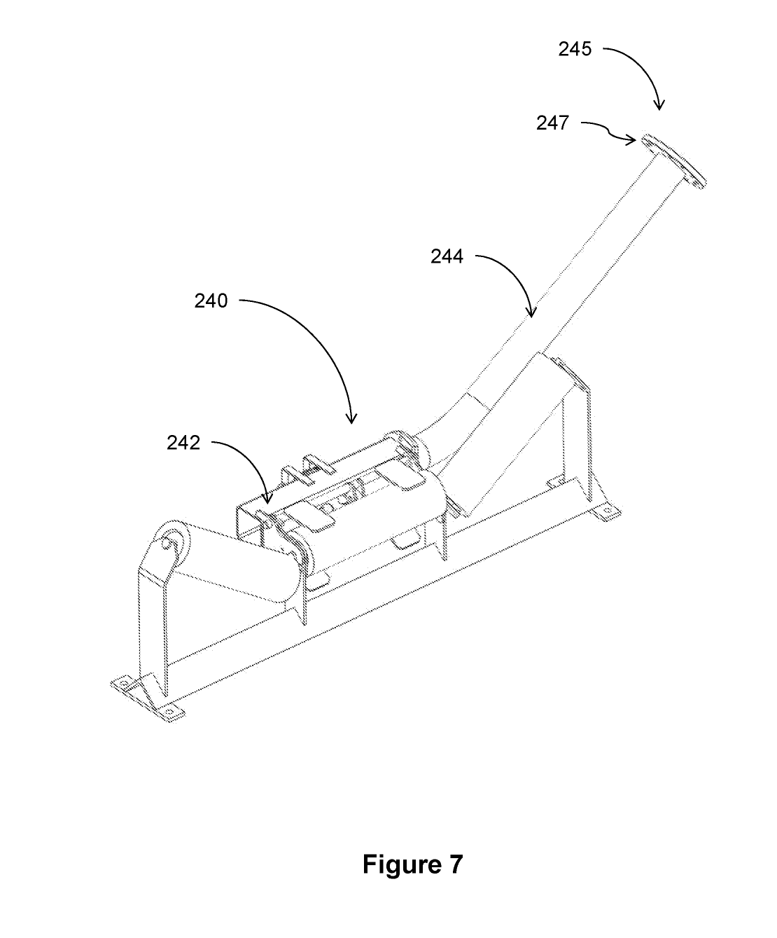

As afore-described, the repair of a conveyor belt roller assembly 102 may comprise replacing worn or faulty rollers and embodiments extend to tools for facilitating such a repair. In this regard, and with additional reference to FIG. 7, there is shown a roller replacement apparatus 240 comprising a retaining portion 242 coupled to an arm extension 244. The arm extension 244 has a free end 245 which in turn attaches to an attachment means of a manipulatable robot arm, such as the arm 230 as afore-described with reference to FIG. 6. In this case, the free end 245 of the arm extension 244 includes a flange 247 comprising a plurality of bolt holes for receiving bolts which extend from the wrist portion 238 of the robot arm 230.

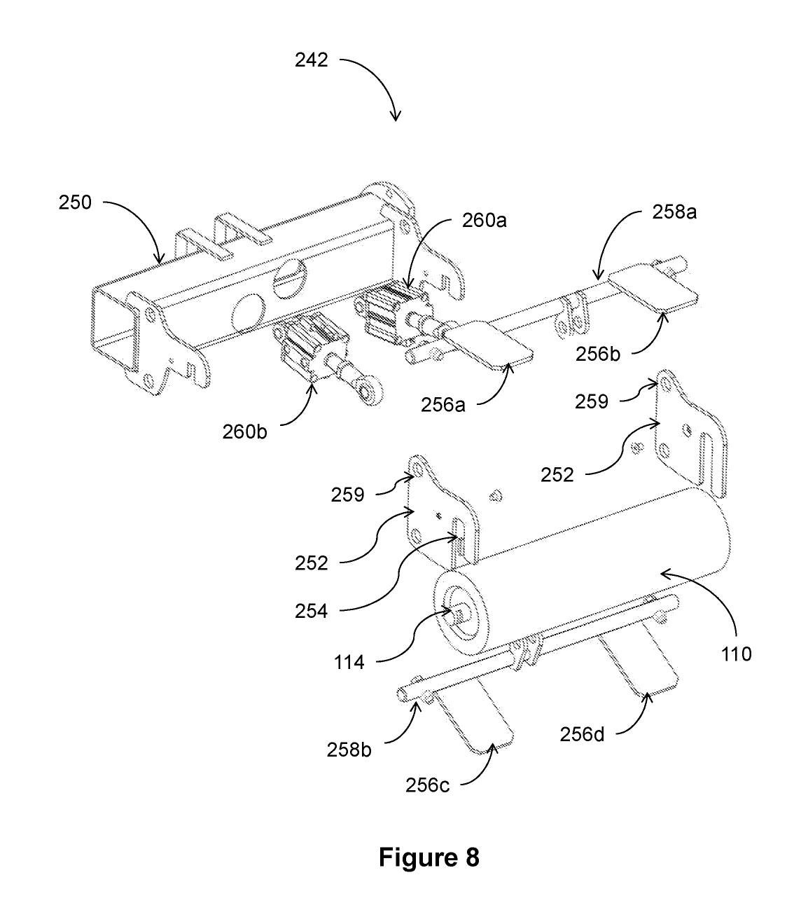

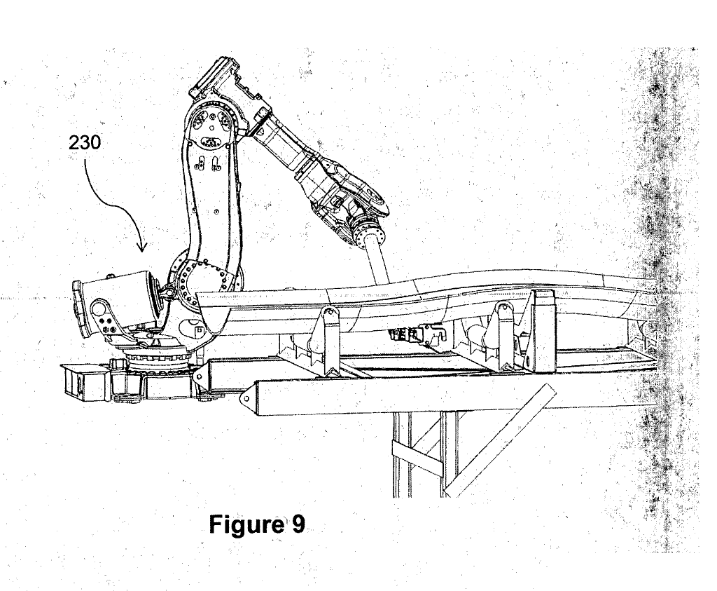

An exploded view of the retaining portion 242 and roller 110 is shown in FIG. 8. As shown, the retaining portion 242 comprises a body 250 on which is located a pair of end plates 252. A spindle locating channel 254 is defined in each of the end plates 252 which, in use, is arranged to receive a respective spindle 114 of the mounted roller 110. A series of flaps 256a, 256b, 256c, 256d are disposed (in this case welded) on bars 258a, 258b which in turn are rotatably mounted within upper and lower bar holes 259 respectively, located within the end plates 252. The bars 258a, 258b are rotatable under the control of respective mechanical actuators 260a, 260b (in this case being in the form of pneumatic pistons, although it will be understood that any suitable mechanical actuator could be utilised to rotate the bars 258a, 258b). In a retaining mode, the bar 258b is rotatable in an anti-clockwise direction such that the retaining flaps 256c, 256d move upwardly thereby causing the spindles 114 to seat and be retained within the respective channels 254 for grabbing and holding the roller 110 during a replacement operation. To release the roller 110, bar 258b is rotated in clockwise direction thereby causing the flaps 256c, 256d to move downwardly, in turn allowing the spindles 114 to be released from the respective spindle locating channels 254. Bar 258a may also be rotated in a clockwise direction to apply pressure to the roller 110 for assisting with the ejection of the spindles 114 from the channels 254.

It will be understood that the database of conveyor features as previously described may be additionally programmed to include data identifying the locations of the rollers and/or spigots for each assembly 102, thereby allowing the robot arm 230 to guide the roller replacement apparatus 240 into location without contacting the moving belt 112. Again, the location ability may be augmented by the additional sensors (e.g. laser, vision, etc.) and mechanical actuators to allow a more precise location of the roller replacement apparatus 240 with respect to the roller 110. Alternatively, in one embodiment the robot arm 230 may be manually guided into position by an operator using the input means.

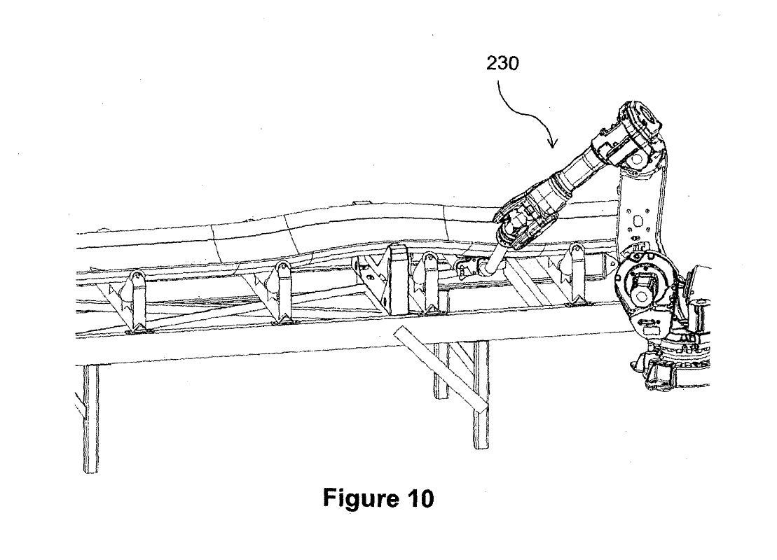

A basic process for replacing a roller 110 using the roller replacement apparatus 240 will now be described. In a first step S1, the roller retaining portion 242 is guided by the robotic arm 230 into the conveyor space such that an open end of each spindle locating channel 254 is aligned with a corresponding spindle 114 of the roller. FIG. 9 shows the roller retaining portion 242 moving toward the assembly 102 and into the aligned location. At step S2, the roller retaining portion 242 is lowered such that the spindles 114 are received in the corresponding spindle locating channels 255. At step S3, the mechanical actuator 260b is actuated thereby causing the retaining flaps 256c, 256d to engage the roller 110 such that the spindles 114 are moved into the corresponding channels 255 and out of engagement with the stanchion channels 116. The roller retaining portion 242 is then manoeuvred away from the conveyor 100 by the robotic arm 230 (step S4). This is best shown in FIG. 10. The robotic arm 230 may, for example, manoeuver the roller retaining portion 242 over a bin or roller rack mounted on a vehicle to which it is mounted. The actuators 260a, 260b may then be actuated to release the roller 110 into the bin or rack.

At step S5, a replacement roller is grabbed by the roller retaining portion 242 (e.g. from the rack or bin using the same locating and retaining methodology as discussed above) or placed into the retaining portion 242 by an operator. The replacement apparatus 240 is then guided by the robotic arm 230 into the same position as for step S1 and the actuators 260a, 260b actuated to release the replacement roller 110 such that it seats on the corresponding stanchion channels 116 (step S6). Steps S1 to S6 are then repeated for any of the other rollers 110 of the assembly that need to be replaced. Once completed the robotic arm 230 may be moved to another assembly location and the process repeated.

The robotic arm 230 may additionally be used to carry a roller inspection tool for inspecting rollers for wear or failure. For example, the robotic arm 230 may be mounted on a vehicle (as afore-described) which makes its way along the conveyor inspecting the rollers of each roller assembly to determine whether they are in need of repair (responsive to which the robotic arm 230 may advantageously be coupled to the various apparatus 200, 240 as described above for facilitating the repair process). In an embodiment the inspection tool comprises one or more sensors such as thermo-graphic sensors, audible sensors, roller diameter sensors or the like. In a particular embodiment, a thermal camera may be arranged to scan a diameter and location of the roller (i.e. guided by the robotic arm 230) to determine whether the surface is excessively warn or includes any uneven portions that may hinder the smooth operation of the conveyor. The sensors may be attached to the wrist portion 238 of the robotic arm 230 using a suitable coupling. Again, the robotic arm may be manually guided by an operator to perform the sensor measurements, or automatically guided using the control software as afore-described.

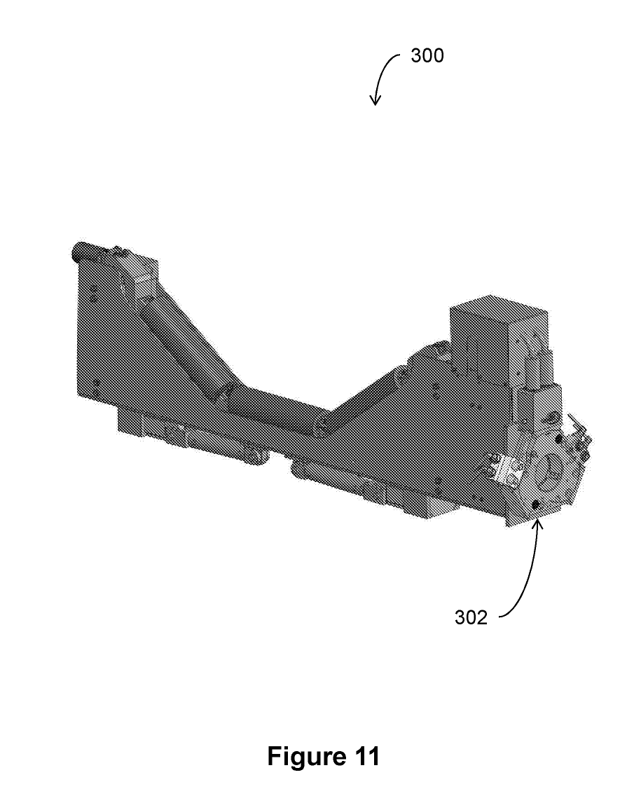

Referring to FIG. 11 an alternative embodiment of a belt lifting apparatus 300 is shown. This embodiment includes a coupling 302 which mounts apparatus 300 to the end of the robotic arm 230 to allow the robotic arm to carry the apparatus 300 to manoeuvre it into position, and also provides hydraulic, pneumatic or electrical coupling to allow functions of the apparatus to be controlled and actuated by way of the robotic arm 230. The rollers of the apparatus can be raised or lowered by an arrangement of hydraulic rams (not visible) in a similar fashion to the earlier described embodiment 200.

Referring again to FIG. 1, the belt of the conveyor is formed into a continuous loop with an upper “carrier” run and a lower “return” run. Although not shown in the figure, the conveyor 100 would typically have a second series of rollers mounted below the rails 104 which support the return run of the belt 112. The return run of the conveyor does not convey material and travels in the opposite direction to the upper portion of the belt. The load on the rollers of the return run is lower than the load on the upper rollers, but they too require maintenance and embodiments of the invention are suitable for use in maintaining the lower sets of return rollers.

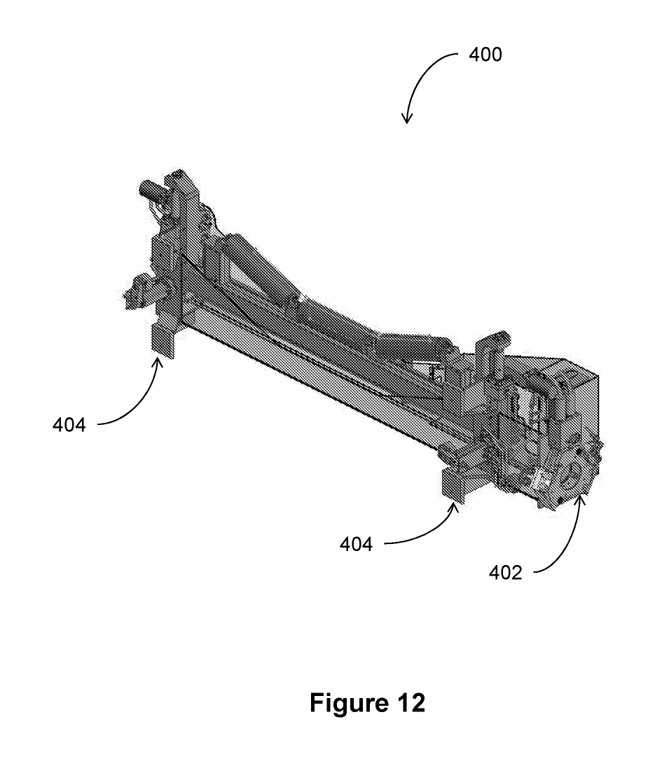

Referring to FIG. 12, a further alternative form of belt lifting apparatus 400 is shown. This version is intended for use in relation to the lower return run of the belt. A coupling 402 is provided as for apparatus 300. Formations 404 are provided which allow the apparatus 400 to be clamped to the supporting legs of the conveyor assembly 100. Apparatus is hydraulically actuated to lift the conveyor belt in a similar manner to the previously described embodiments.

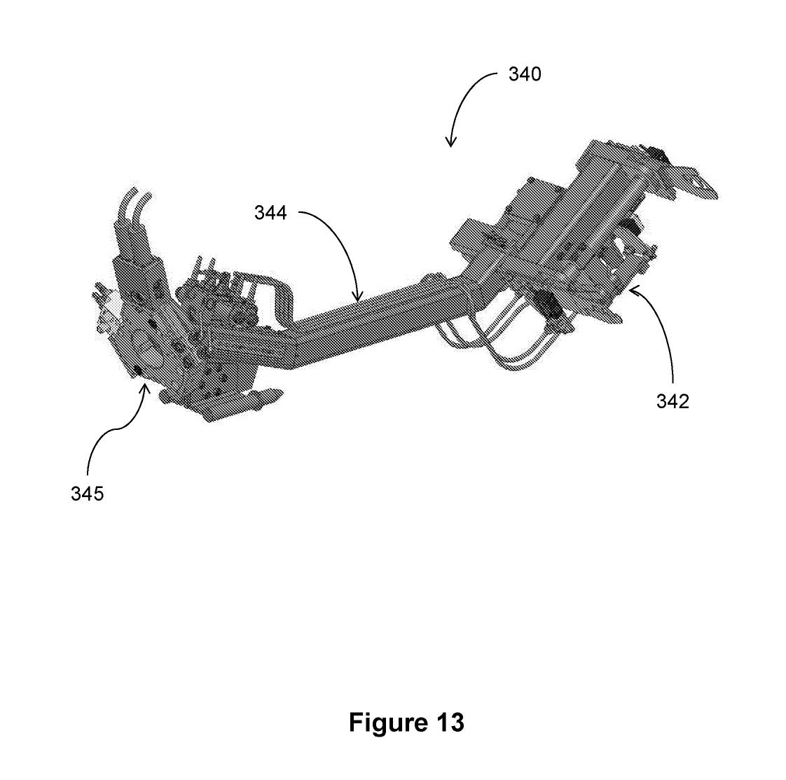

Referring to FIG. 13, an alternative embodiment of a roller replacement apparatus 340 is shown. This embodiment differs from the embodiment 240 in that coupling 345 facilitates both mechanical engagement of the robotic arm 230 and also hydraulic or other powered connections between the robotic arm 230 and the roller replacement apparatus. Furthermore, the retaining mechanism 342 for engaging the rollers has been modified.

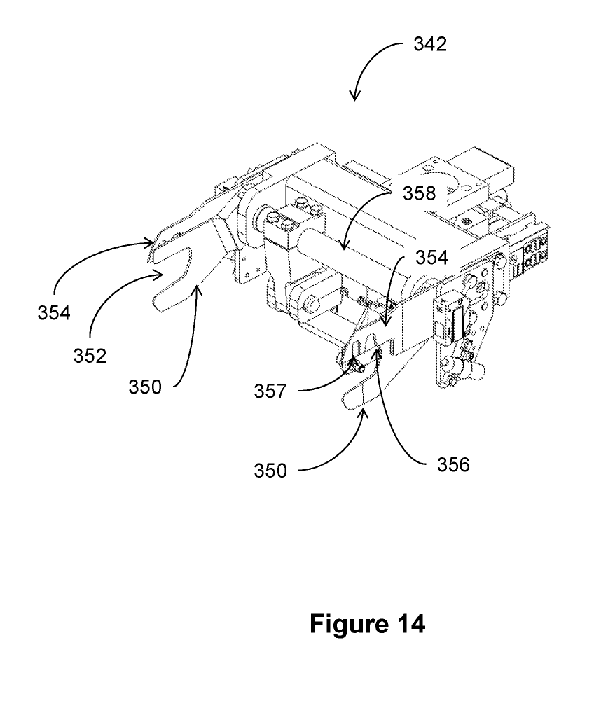

As better seen in FIG. 14, the retaining mechanism includes two side plates 350 in which are provided a large aperture 352. Two capture plates 354 are provided in association with the side plates 350. The capture plates each include a small notch 357 and a large notch 356. The retaining mechanism is used to both remove and to install rollers in the roller carriers.

To remove a roller, the retaining mechanism is brought up to the roller so that the ends of the spindle of the roller enter into the large apertures 352. When the spindle of the roller is aligned with the large notch, the capture plates are actuated by way of a hydraulic actuator to rotate by way of rotating shaft 358. This causes the spindle of the roller to become captured at each end in the large notches 356. The roller is therefore securely held by the retaining mechanism which can be lifted by way of suitable movement of the robotic arm 230 to remove the roller from its mounting and to withdraw the roller from the conveyor assembly.

The removed roller is released from the retaining mechanism and a new roller is placed in the retaining mechanism for installation. When installing a roller, the roller is held in the retaining mechanism by way of the spindle of the roller being captured in the small notches 357 of the capture plates. The small notches are just larger than the diameter of a roller spindle. Therefore, when a roller is held in the smaller notches 357 its position in the retaining mechanism is accurately known which allows for accurate placement of the roller in the roller carrier assembly to install a roller. When removing a roller, the use of the larger notches provides for a larger degree of tolerance to assist the retaining mechanism in grasping the roller.

Additional sensors are mounted in associated with the retaining mechanism such as positional or image sensors to allow for precise positioning of the retaining mechanism when picking up or installing rollers.

Retaining mechanism 342 may be mounted to arm 344 in a right handed or left handed orientation, or may be mounted to the arm with an articulated moveable joint to allow for adjustment of the attitude of the retaining mechanism 342 with respect to the arm 344.

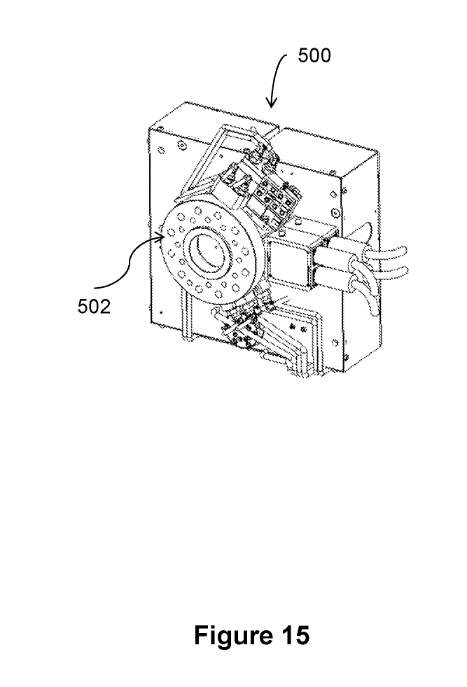

Referring to FIG. 15, an inspection tool 500 is shown. The inspection tool includes a coupling 502 to allow coupling to a robotic arm 230. The inspection tool includes various sensors such as a three dimensional camera array or laser rangefinder which allow for a machine inspection of a region of the conveyor. Such an inspection may be carried out prior to a maintenance operation by the robotic arm to provide the robotic arm with reference data to enable it to locate its operations in relation to the conveyor assembly to avoid collisions and check for the presence of obstructing debris and to allow for accurate location and installation of components (i.e. for storing the database of conveyor features as afore-described). Tool 500 may further include a camera such as a CCTV camera which provides a visual output which can be monitored by a local or remotely located human operator.

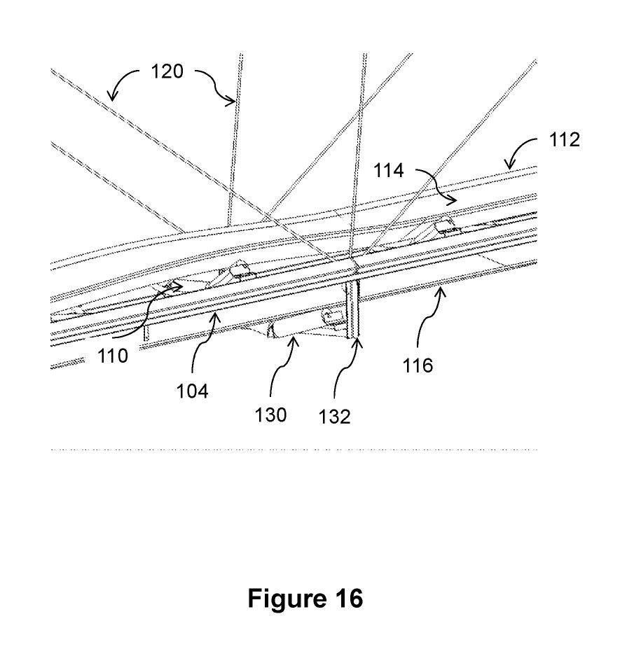

Referring to FIG. 16, an alternative type of conveyor installation is shown which is commonly employed in conveyor belt arrangements which are installed in underground tunnels. The conveyor belt 112 again has an upper carrier run 114 and a lower return run 116. Side rails 104 are suspended on cables 120. A series of spaced apart carrier roller assemblies 110 are mounted between the rails. A series of spaced apart return roller assemblies 130 are mounted on struts 132 which depend from the rails.

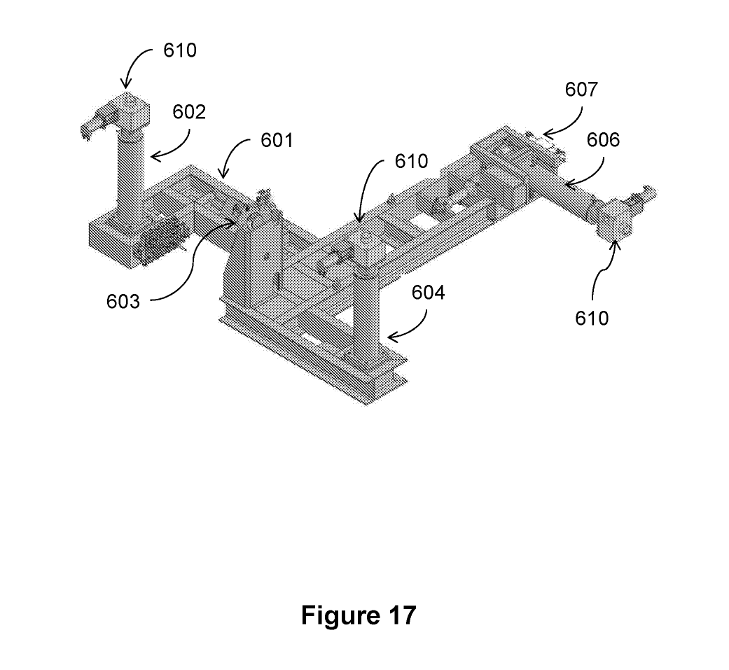

Embodiments will now be described which are intended for use in relation to underground conveyor belt installations. Referring to FIG. 17, a base 600 is shown which includes a frame 601 and three hydraulically actuated screw jacks 602, 604, 606. Jacks 602, 604, 606 each have a lifting capacity of approximately 5 tonnes. On the end of each jack is mounted a locking actuator 610 which includes a retractable rod which can be retracted or extended to lock each jack in relation to the side rails 104 of the conveyor. In the figure, the jacks 602, 604 and 606 are shown in their retracted configurations. Jack 606 is pivotally mounted to the frame and may be moved between a flattened position as shown to an upright position. A coupling 603 is provided which can be connected to by a robotic arm 230 to manipulate the base 600 and to control the various hydraulic functions of the base.

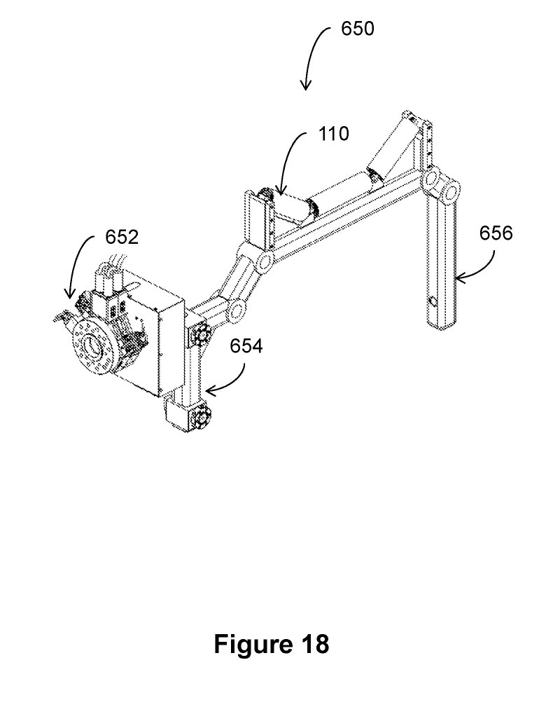

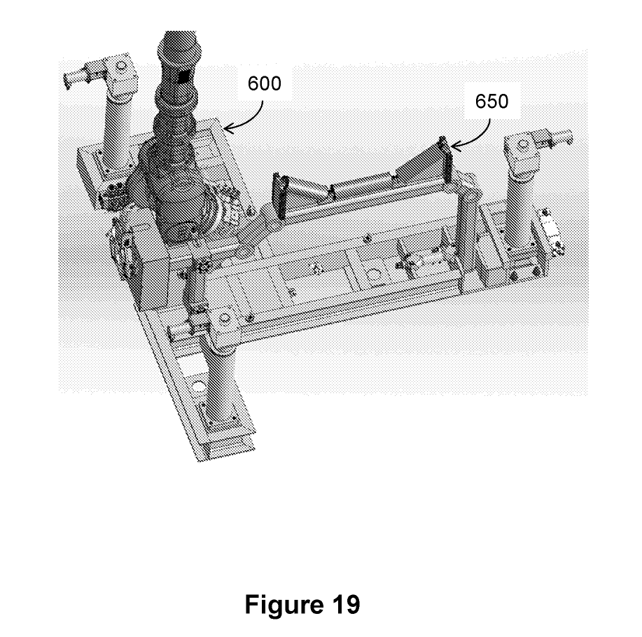

Referring to FIG. 18, an insert 650 is shown for use in association with base 600. The insert includes a coupling 652, two legs 654, 656 and an arrangement of rollers 110. Legs 654, 656 are lockable to the base by activating hydraulically operated locking mechanisms as shown in FIG. 19.

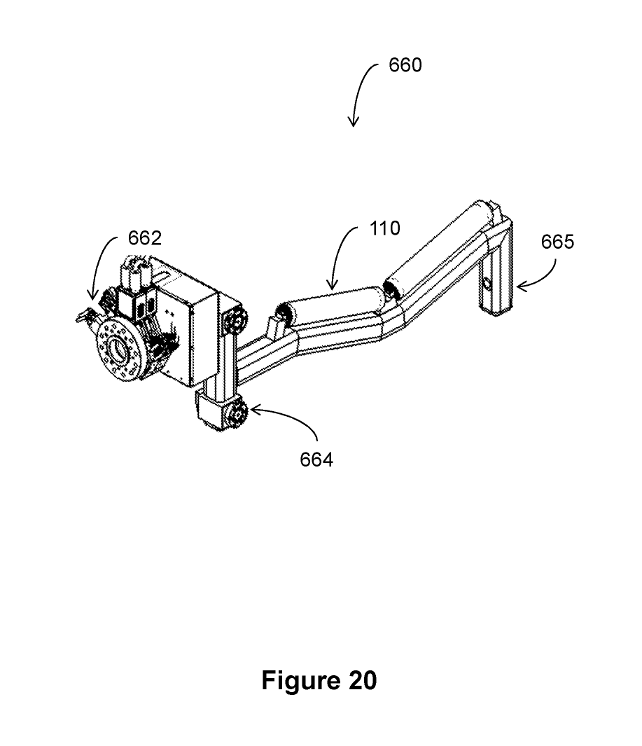

At FIG. 20, an alternative insert 660 is shown which can also be used with base 600. This insert differs in the length of its legs 664, 665. Insert 650 is intended for use in performing maintenance work on rollers supporting the upper series of carrier rollers. Insert 660 is intended for use in performing maintenance work on the lower series of return rollers.

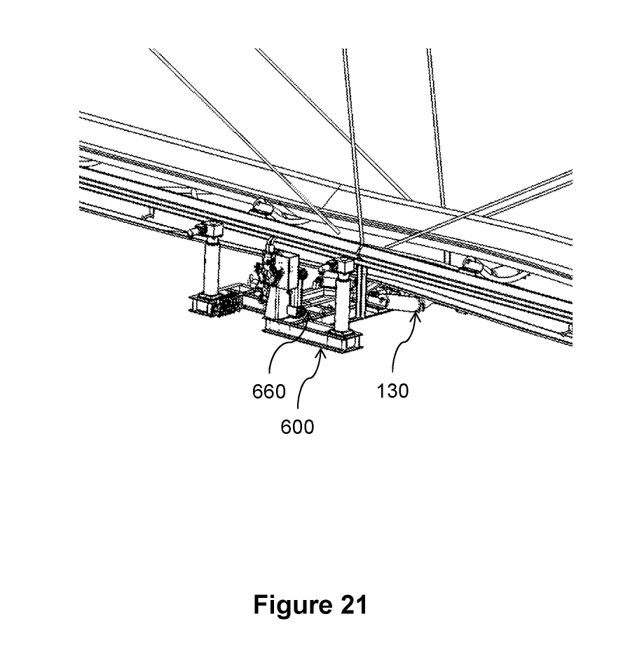

Operation of the base 600 with insert 660 will be described with reference to FIG. 21. Initially, the base 600 is selected by the robotic arm 230 and is put into the configuration shown in FIG. 17 with jacks 602, 604 and 606 retracted and with jack 606 in its horizontal position. The base is then manipulated by the arm to bring it into position underneath the conveyor belt adjacent to the set of rollers which requires attention. Jack 606 is brought to its upright position by actuation of actuator 607. The jacks 602, 604, 606 are then extended and the locking actuators 610 are actuated to lock the frame in relation to the side rails 104. The frame is now in a lowered position and is hanging from the side rails by way of engagement of the upper ends of the jacks with the side rails.

Robotic arm disengages from base 600 and selects insert 660 by engaging with the coupling 662 of the insert. The robotic arm manipulates the insert to bring it into engagement with frame 600 and operates the locking actuators to lock the insert 660 to the frame 600.

Robotic arm disengages from insert 660 and again engages with the coupling 602 of frame 600. The robotic arm then operates jacks 602, 604 and 606 to retract the jacks. This draws the frame 600 and the insert 660 upwards. As insert 660 rises up, the rollers 110 of the insert lift the return portion of the conveyor belt away from the set of return rollers 130. The robotic arm may then disengage from the frame 600 to select a roller replacement apparatus 240 to effect removal and replacement of one or more of the set of rollers 130. Following completion of the maintenance work, a reverse procedure is used to remove the frame and insert from the conveyor.

In an alternative embodiment to that described with reference to FIGS. 17 through 21, instead of the base 600 being secured to the side rails 104 for elevation it instead projects itself off the ground so as to bring the insert 660 into engagement with the belt. According to this alternative embodiment, the jacks 602, 604 and 606 may be configured to extend downwardly for engaging with the ground and in turn raise the platform upwardly toward the belt. Once in the raised position the jacks may be locked in place (e.g. using hydraulic locking means) while the repair is being effected (in much the same manner as afore-described).

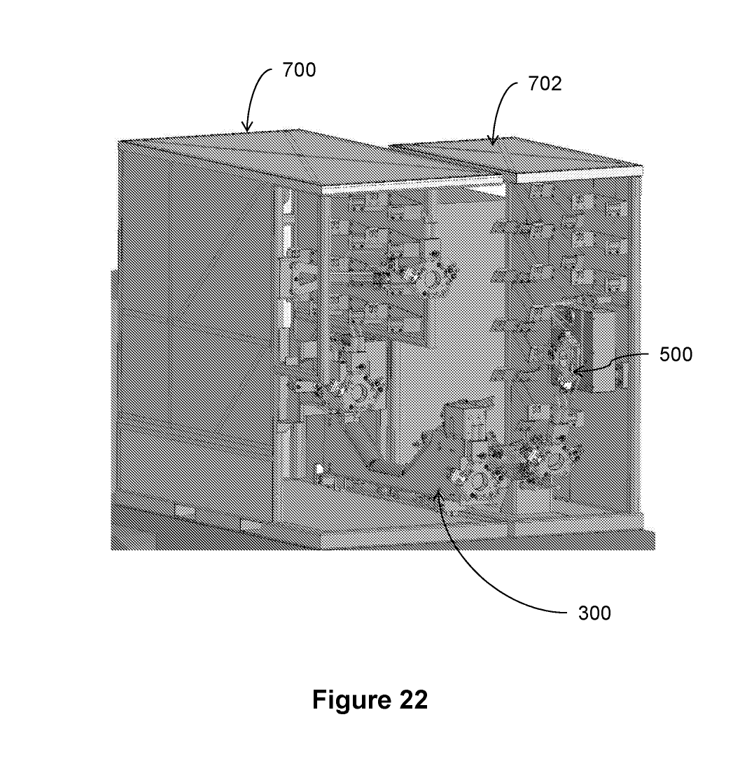

Referring to FIG. 22, the various apparatus which the robotic arm couples to are stored in modular storage units 700, 702. The storage units have specially configured bays for storing each of the apparatus used by the robotic arm in various maintenance tasks. The storage unites also include bays for storing new and used conveyor rollers. By knowing the spatial locations of the storage bays, the robotic arm can retrieve and store various apparatus and rollers.

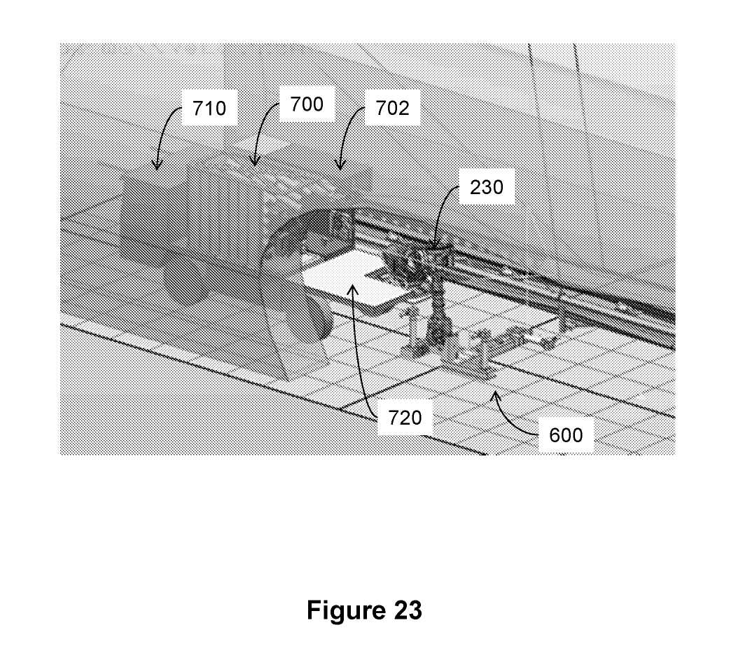

Referring to FIG. 23, the robotic arm 230 may be mounted on a platform 720 of a truck 710. Storage units 700 can be loaded into position on the truck by use of a fork lift truck. The truck can make its way along a passageway alongside the conveyor stopping to make inspections or carry out maintenance work. The driver of the truck can control the operations of the robotic arm from a control station mounted in the cabin of the truck. The suspension system of the truck may be equipped with a levelling capability to enable levelling of the truck to thereby provide the robotic arm with a level frame of reference.

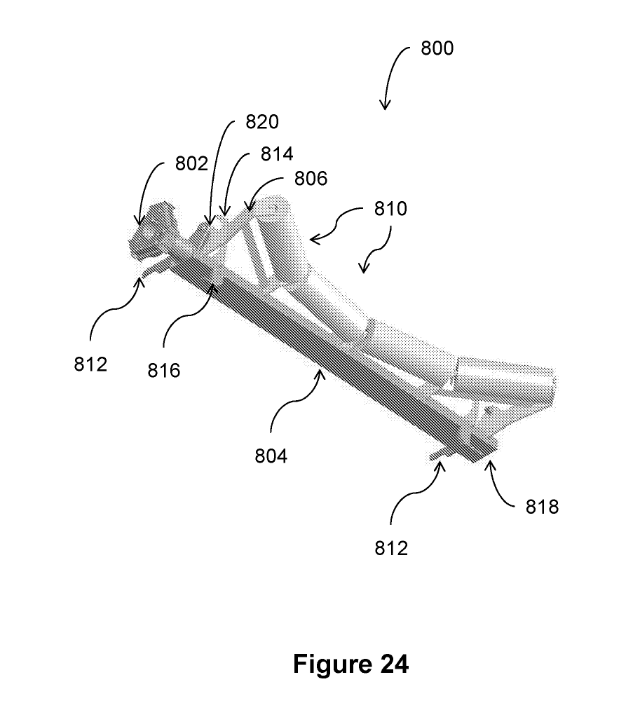

Referring to FIGS. 24 to 28c an alternative embodiment of a belt lifting apparatus 800 is shown. This apparatus is intended for use in relation to above ground conveyor arrangements of the type shown in FIG. 1. The apparatus is intended for use to prevent damage to the conveyor belt by a damaged roller. The apparatus is used to temporarily lift up the conveyor belt off the damaged idler roller while the conveyor belt is running with full load.

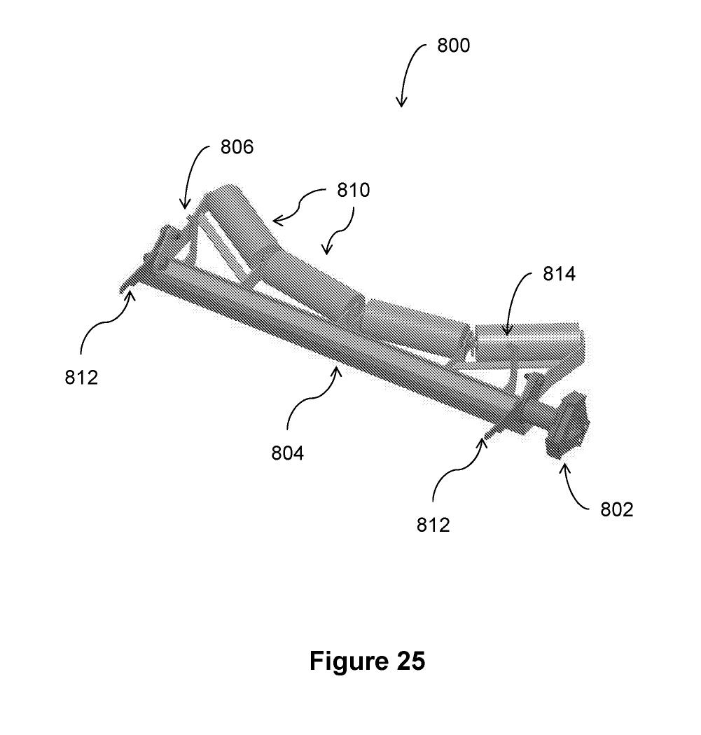

Referring to FIGS. 24 and 25, apparatus includes a base frame 804 to which is pivotally mounted a roller carrier frame 806 to which is mounted a series of rollers 810. A coupling 802 is provided for attachment with a robotic arm 230 so that the robotic arm can carry and manipulate the apparatus 800. The carrier frame 806 may be rotated with respect to the base frame by rotation of the coupling 802 which is connected to the carrier frame by way of a torque limiting coupling 820.

A short hook 816 and a long hook 818 are provided on the bottom surface of base frame 804 and are used to affix the apparatus 800 to the side rails of a conveyor assembly. Guiding flaps 812 and locking hooks 814 control the installation of the apparatus 800 as will now be described.

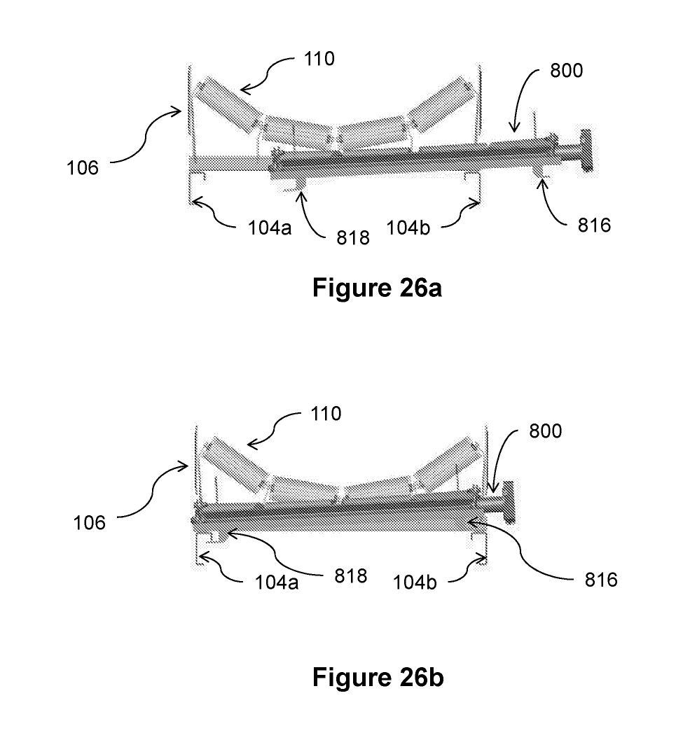

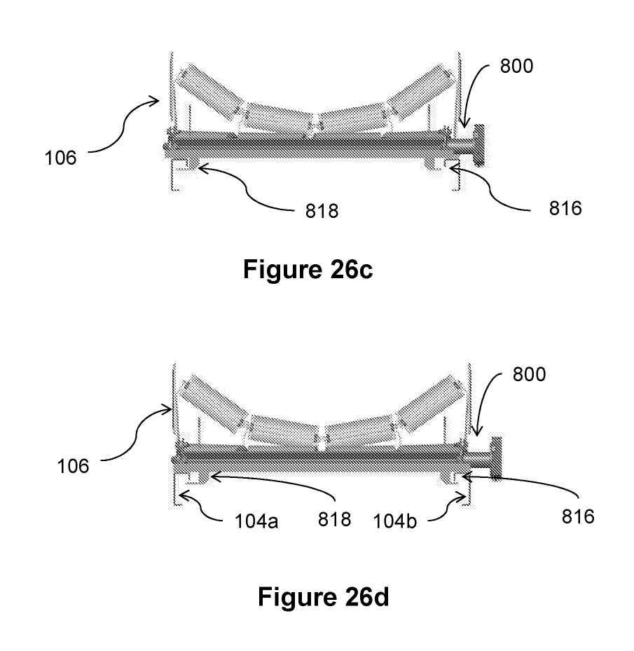

Referring to FIGS. 26a to 26d the robotic arm 230 (not shown) grasps coupling 802 and manipulates the apparatus 800 to insert it at a shallow angle into the conveyor assembly so that long hook 818 engages with side rail 104a (see FIG. 26b). The apparatus is then lowered and shifted towards the robotic arm as shown in FIG. 26d so that the short hook 816 becomes engaged with side rail 104b. The short hook 816 and long hook 818 prevent the apparatus 800 from moving vertically.

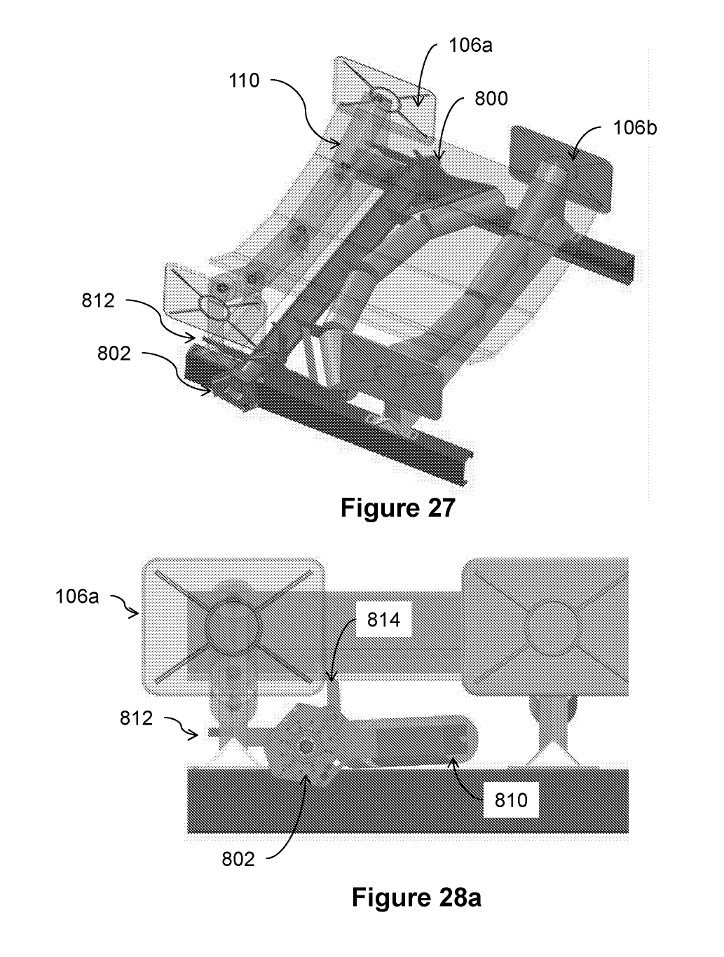

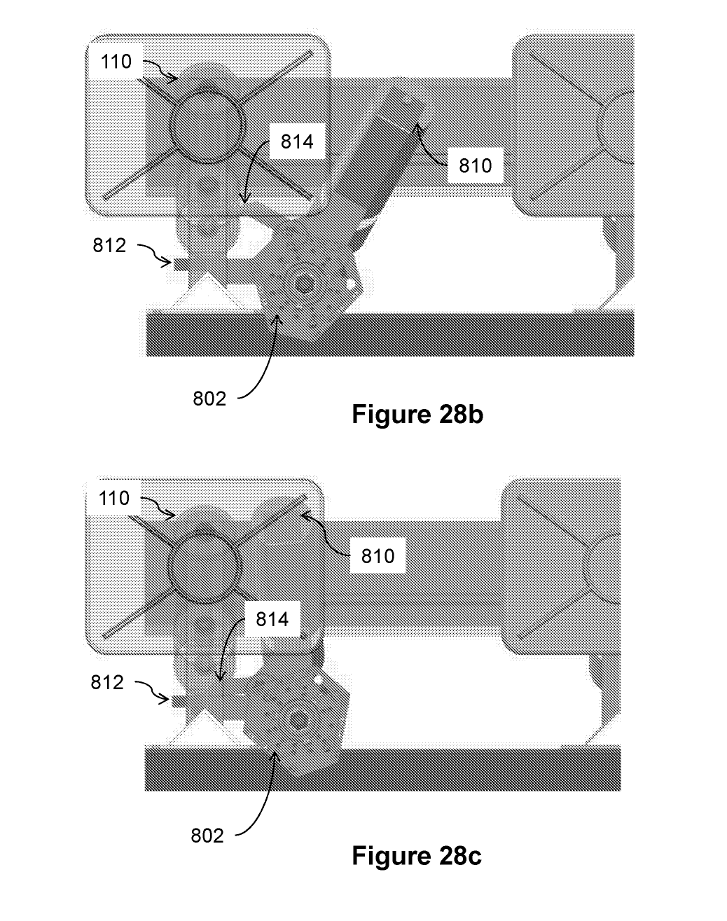

As shown at FIG. 27, the robotic arm 230 moves the apparatus 800 laterally along the rails 104 towards the idler frame 106 upon which is mounted the set of rollers 110 which are to be relieved from the load of the conveyor. As the apparatus 800 comes up against the idler frame, the guide flaps 812, which have inwardly inclines end regions, serve to guide the apparatus 800 to centre the apparatus with respect to the idler frame 106. The apparatus 800 is now in the position shown in FIG. 28a and is ready for elevation of the rollers 810 which is carried out by anti-clockwise rotation of the coupling 802.

Referring to the sequence of FIGS. 28a to 28c, the robotic arm 230 rotates the coupling 802 to bring the rollers 810 to bear against the underside of the conveyor belt at about the position shown in FIG. 28b. Further rotation of the frame 806 causes the rollers 810 to lift the conveyor belt away from the rollers 110 to relieve them of load. The frame 806 rotates until locking hooks 814 come to bear on the idler frame 106.

The locking hooks define the final position of the frame 806 as shown in FIG. 28c. When in this position, the rollers 810 are positioned higher than rollers 110 so that rollers 810 bear the weight of the conveyor belt. The direction of travel of the conveyor belt is from right to left in FIG. 28c which assists in keeping the frame 806 in position. The direction of rotation to install the apparatus is with the direction of movement of the conveyor. As can be seen in FIG. 28c, in the final position of the apparatus 800 the frame 106 has rotated over-centre such that the weight of the conveyor acts to retain frame 806 in position with the locking hooks 814 in engagement with idler frame 106. Apparatus 800 is therefore self-clamping and no hydraulic jacking or additional clamping is required. Such an apparatus can be used to effect temporary relief of load from a damaged roller which can then be later fixed at such time as the conveyor belt is shut down.

Accordingly, from the above, it can be seen that embodiments of the invention have at least one of the following advantages:
The risk of injury to human operators lifting and manoeuvring rollers which are becoming larger and heavier is eliminated, reducing injury risks.
No need to cease operation of the conveyor to replace worn or faulty rollers thereby reducing conveyor down time.
No need for operators to work under or inside conveyor which again has the effect of reducing injury risks.
The time taken to change a roller using the apparatus described herein is much faster than conventional techniques which involve numerous safety check and inspection stages that are obviated by the present invention.

Although the invention has been described with reference to the present embodiments, it will be understood by those skilled in the art that alterations, changes and improvements may be made and equivalents may be substituted for the elements thereof and steps thereof without departing from the scope of the invention. Further, many modifications may be made to adapt the invention to a particular situation without departing from the central scope thereof. Such alterations, changes, modifications and improvements, though not expressly described above, are nevertheless intended and implied to be within the scope and spirit of the invention. The above described embodiments are therefore not to be taken as being limiting in any respects.

Any reference to prior art contained herein is not to be taken as an admission that the information is common general knowledge of the skilled addressee in Australia or elsewhere.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. An apparatus for facilitating repair of a conveyor belt idler frame assembly during operation of a conveyor, the apparatus comprising:
an interim belt support structure comprising one or more rollers, the support structure being operable to be positioned adjacent the idler frame assembly and, once so positioned, being further arranged to anchor to a support portion of the conveyor; and
an elevating arrangement arranged to elevate the roller(s) of the interim belt support structure into engagement with a moving belt of the conveyor to facilitate the repair.

2. An apparatus in accordance with claim 1, wherein the elevating arrangement is configured to elevate the roller(s) to a height such that the moving belt is no longer in contact with rollers on the adjacently located idler frame assembly.

3. An apparatus in accordance with claim 1 or 2, wherein the elevating arrangement comprises a mechanical actuator.

4. An apparatus in accordance with claim 3, wherein the mechanical actuator comprises a hydraulic cylinder.

5. An apparatus in accordance with any one of the preceding claims, further comprising a manipulatable robot arm arranged to removably couple to the interim belt support structure and, when so coupled, to guide the interim belt structure into the adjacent position.

6. An apparatus in accordance with claim 5, wherein the manipulatable robot arm comprises a sensing means arranged to sense an area adjacent the idler frame assembly to be repaired for determining how to guide the interim belt structure into the adjacent position without contacting the moving belt.

7. An apparatus in accordance with claim 5, wherein the manipulatable robot arm comprises a user input for allowing the interim belt support structure to be guided into position by an operator.

8. An apparatus in accordance with any one of claims 5 to 7, wherein the manipulatable robot arm is mounted to a movable platform comprising a drive means for driving the manipulatable robot arm into a suitable position for facilitating guiding of the interim belt support structure into the adjacent position.

9. An apparatus in accordance with any one of the preceding claims, wherein the interim belt support structure is arranged to anchor to one or more support rails of the conveyor on which the idler frame assembly is mounted.

10. A conveyor belt system comprising:
a conveyor belt comprising a plurality of conveyor idler frame assemblies arranged to carry a moving belt; and
an apparatus as claimed in any one of claims 1 to 9, for facilitating repair of one of the idler frame assemblies.

11. A method for repairing an idler frame assembly supporting a conveyor belt during operation of a conveyor, the method comprising:
positioning an interim belt support structure comprising one or more rollers adjacent the idler frame assembly;
anchoring the interim belt support structure in the adjacent position; and
elevating the roller(s) of the interim belt support structure into engagement with a moving belt of the conveyor to facilitate the repair.

12. A method in accordance with claim 11, further comprising elevating the roller(s) to a height such that the moving conveyor belt is no longer in supported by the adjacently located idler frame assembly.

13. A method in accordance with claim 11 or 12, further comprising replacing or repairing one or more of the rollers of the adjacently located idler frame assembly while the interim belt support structure is taking the load of the moving belt off the idler frame assembly.

14. A method in accordance with claim 13, further comprising lowering the height of the roller(s) of the interim belt support structure after the one or more rollers have been replaced or repaired.

15. A method in accordance with claim 14, further comprising removing the interim belt support structure from the adjacently located position.

16. A roller replacement apparatus for facilitating repair of a conveyor belt idler frame assembly mounting one or more rollers, the apparatus comprising:
a manipulatable arm coupled to a retaining portion and being arranged to move the retaining portion into a position adjacent one of the rollers mounted by the idler frame assembly such that when so positioned the retaining portion is arranged to receive and retain the roller by way of spindles disposed on either end thereof.

17. A roller replacement apparatus in accordance with claim 16, wherein the retaining portion comprises a pair of plates disposed on either end of a body, each of the plates comprising a spindle retaining channel operable to receiving a respective spindle of the roller.

18. A roller replacement apparatus in accordance with claim 17, wherein the retaining portion further comprises on or more movable projections which extend from the body and which are locatable under the roller when the retaining portion is located in the adjacent position, in use the projection(s) being moveable so as to bear on the roller for causing the spindles to move out of the mounted position on the idler frame assembly and into the respective spindle retaining channels.
